(19) United States
(12) Patent Application Publication
(10) Pub. No.: US 2013/0081133 A1
(43) Pub. Date: Mar. 28, 2013

(54) SYSTEM AND METHOD FOR UNLOCKING AN ELECTRONIC DEVICE

(71) Applicant: Barnesandnoble.com IIc, New York, NY (US)

(72) Inventor: Patrick Hetroy, New York, NY (US)

(73) Assignee: BARNESANDNOBLE.COM LLC, New York, NY (US)

(21) Appl. No.: 13/624,168

(22) Filed: Sep. 21, 2012

Related U.S. Application Data
(60) Provisional application No. 61/538,459, filed on Sep. 23, 2011.

(51) Int. Cl. G06F 21/00; G06F 3/033

(52) U.S. Cl. 726/16; 715/863

(57) ABSTRACT

A system and a method facilitating the unlocking of a locked touch screen device. In a preferred embodiment, the device is an e-reader device. The system and method provides a device unlock screen that simulates turning a page in a book rather than sliding a dead bolt lock or moving some other object from one place to another on the locked screen.

### CROSS-REFERENCE TO RELATED APPLICATION

This application claims benefit of U.S. Provisional Application No. 61/538,459, filed Sep. 23, 2011, which is hereby incorporated by reference.

### FIELD OF THE INVENTION

The present invention generally relates to systems and methods for using touch screens, and more particularly to systems and methods for unlocking mobile devices.

### BACKGROUND OF THE INVENTION

Mobile devices often wake up to an “unlock screen,” requiring the user to perform some action to start using the device. For example, the iPhone™ requires the user to slide a virtual button across a strip; and the Android™ system has something similar to a virtual dead bolt.

### SUMMARY OF THE INVENTION

The present invention provides a system and a method for unlocking of a touch-screen user-interface device that is particularly suited to an e-reader device. The present invention provides a device unlock screen that simulates turning a page in a book rather than sliding a dead bolt lock or moving some other object from one place to another.

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIG. 1 illustrates the features of the present invention;

FIG. 2 is flow chart illustrating some preferred methods of the present invention; and

FIG. 3 illustrates an electronic device incorporating the present invention.

### DETAILED DESCRIPTION OF THE INVENTION

In the basic embodiment of the present invention, the user turns a virtual page in a virtual book to unlock an e-reader device. In certain mobile devices, if the user has set his security to require a PIN or password, the device presents a PIN or password entry dialog prior to, after, or instead of the “turn the page” unlock screen. In more advanced embodiments of the present invention, if the device's security is set to require a PIN or password, then the user either enters the PIN or password in a PIN or password entry dialog after the simulated page turns; or she enters the PIN first and then turns the simulated page; or she enters the PIN at which point the device simulates the page turn (i.e., animate the page turning) without the user having to manually turn the virtual page.

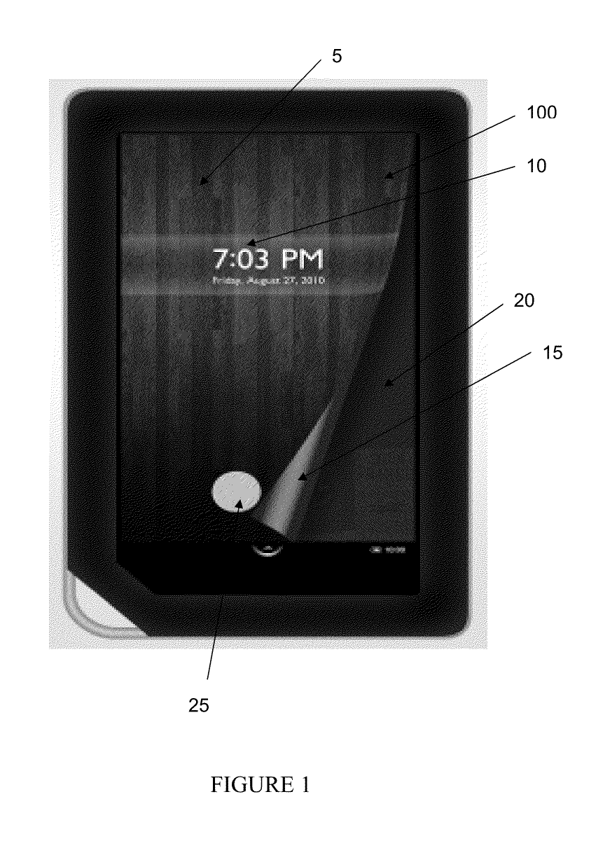

Most devices have a “sleep” state power saving mode in which the display is turned off. The user typically has to activate a control, e.g., a button to “wake” the device and exit the sleep state. As illustrated in FIG. 1, after waking the device 100, the device 100 starts in a “locked” state. This “locked” state is a security state in which unintentional or unauthorized operation of the device 100 is prevented. In the preferred embodiment, the device 100 displays a lock screen that is lightly dimmed version of the user's current wallpaper 5, e.g., the same wallpaper used on a Home screen of the device 100. In this preferred embodiment, the time and date 10 are displayed on the screen of device 100.

Depending on the user's security setting, the “locked” home screen 5 of device 100 displays a graphic 15, a PIN entry key-pad (not shown) or both. The user slides the unlock graphic 15 (or enters their PIN), and the screen 20 that was displayed before the device 100 went to sleep is re-displayed (e.g., a page in an e-book). If the device 100 has just been restarted, the Home screen is displayed. In a preferred embodiment, the screens that are displayed after the device 100 is unlocked, fade in.

If security settings are set so a PIN is required, then the behavior can be nearly identical to traditional PIN entry behavior, except when the user enters her correct PIN, the transition animation to the application starts with a full 3D page-turn/flip animation as described below.

In one embodiment, the display screen 20 uncovered during the page turning unlocking is just a dark gray or black background, fading into the application content as the application starts. In another embodiment, the prior state can be cached. If no PIN is required, then instead of sliding a lock icon, the user can “turn the page” from the lower-right corner.

The user interface shows a 3D page curling effect 15 as the user pulls up the page/wallpaper 5 to start unlocking the device 100. When the user “flips the page” more than halfway (e.g., the user's finger performing the unlock gesture passes the mid point of the display), the completion of the animation of the turning page is depicted if the user didn't drag the curling unlock page 15 all the way herself, and the device 100 is unlocked.

Note that the white circle 25 illustrated in FIG. 1 represents the finger's contact point. This circle 25 does not appear in the user interface of the device 100 when the invention is in use, it is merely used in FIG. 1 for illustrative purposes

If the user merely “flicks” the lock page 5 without dragging it a minimum distance, the page 5 is illustrated as just curled up a little bit 15, and is animated to flap back down and the device 100 remains locked.

In an alternative embodiment, the lock page/wallpaper 5 is started completely flat. When the user presses the home button (or if she shakes the device) the lower right corner of the page 15 curls up a bit and falls back down (over a few seconds). This action of curling and uncurling is intended to provide the user with a visual cue that informs the user that she can turn the page 5 to unlock the device 100. This animated curling 15 of the lock wallpaper 5 is an option that can be set by the user. Alternatively, the curling 15 can be a static visual cue to the user, without the curling animation. To increase security, the user can set the device 100 to display the flat lock screen 5 without any visual cues 15 at all. In this embodiment, security is increased because an unauthorized user would not know how to unlock the lock screen 5.

In an alternative embodiment, if the above visual cue proves to be too subtle, the device 100 can be programmed to display more explicit cues or instructions, such as having the page partially curled up 15 from the start, and displaying the text “flip/turn page to unlock” on the display screen.

In an alternative embodiment the page can be turned left to right, right to left, top to bottom, bottom to top, or multiple directions.

In another alternative embodiment, it can be varied how far a user needs to turn/slide the page edge 15 for the unlock to proceed. In a preferred embodiment, the user would have to turn the edge of the page 15 at least close to the horizontal midway point of the display.

In a further alternative embodiment, the system could allow a “flick” to turn the lock page 5, though in a preferred embodiment, it is preferred to require the user to move the page edge 15 at least an inch across the page, as a short flick can be unintentional.

In more advanced embodiments, if the device's security is set to require a PIN, then the user would either enter the PIN in a PIN entry dialog box after the simulated page turn; or she would enter the PIN first and then turn the simulated page; or enter the PIN at which point the device would simulate the page turn without the user manually turning the virtual page.

In addition to a touch-sensitive screen, any device 100 capable of executing the computer operations associated with the present invention is preferably equipped with hardware, firmware and/or software capable of detecting a user touching the device at one or more contact points, and moving in potential multiplicity of directions in simple (single line segment) or compound (>1 line segments) motions; and Firmware and/or software capable of analyzing and interpreting the motion, and forwarding the analyzed contents or interpretation to an appropriate software application or other software subsystem that associates the gestures with the action of unlocking the device.

In a further embodiment, the user traces a figure, e.g., a character such as the letter “n” in order to unlock the device. This compound gesture is interpreted by the device as a command from the user to unlock the device. Again, this gesture can be combined with the above described PIN security mechanisms. Further, the user can be given the option to set their own “password” gesture that would be used to unlock the device. For example, the user can set her password gesture to be the letter “Z” that touches all four corners of the screen, or the user can designate four consecutive taps in the upper right hand corner to be her unlock gesture. This additional security feature can be used to turn the virtual page to unlock the device.

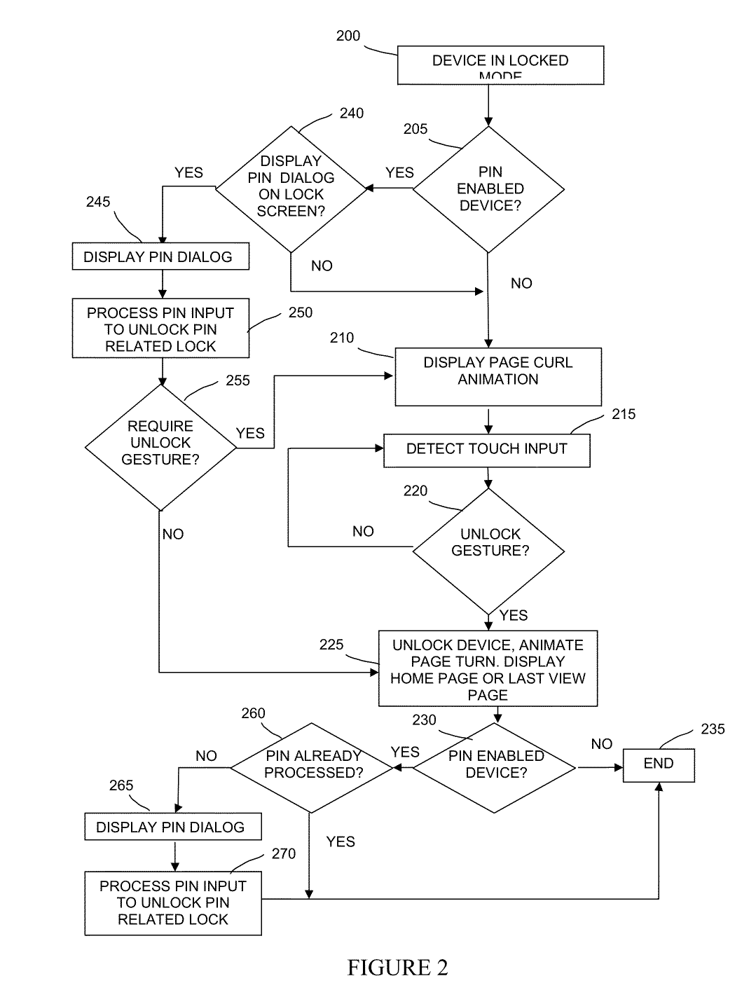

FIG. 2 is flow chart illustrating some preferred methods of the present invention. The process starts with the screen of the device 100 in a locked mode as described above. The first test 205 is whether the device also a has a Personal Identification Number, PIN, enabled security mechanism. As well known in the art, electronic devices can be locked for security reasons and can only be unlocked using a PIN. PIN security is particularly applicable to mobile devices that are more easily lost or stolen. The PIN enabled security allows the user to protect personal or business related information from unauthorized access, e.g. if the device 100 is lost. Whereas the screen lock of the present invention in its preferred embodiment is more likely to prevent unintentional access to the device, the PIN security is intended to prevent unauthorized access. The screen lock of the present invention and the PIN security work synergistically in parallel.

In step 205, if the device 100 is not PIN enabled, the process moves onto step 210. In step 210, the system displays the page curl animation 15 to visually cue the user as to the action required to unlock the device. As described above, this step 210 of the animation or even providing any visual cue to the user to help unlock the device 100 is optional. The system, in step 215 wait for and detects a touch input by user on the touch screen of the device 100. Once the touch is detected, the system then tests the touch to determine if it was a gesture intended to unlock the device 100. As described above, in the preferred embodiment, the user's gesture should travel a certain length, e.g., one inch, to be deemed a legitimate gesture intended to unlock the device. Again, the purpose of the this test is to discriminate unintended touch of the screen which should not act to unlock the screen. The gesture is also preferably tested to insure that it is in the right direction and in the proper location on the display. For example, a left to right gesture at the top of the screen should not be interpreted as an unlock gesture if the system is looking for a right to left gesture at the bottom of the screen. Again, as described above, in the preferred embodiment the system is looking for a right to left gesture near the bottom of the screen, e.g., near the curl animation 15, as a gesture intended to unlock the device 100. The system designer, and or the user can set parameters as to direction, location, shape and length of the gesture required to unlock the device 100.

If the touch by the user is not interpreted as a gesture intended to unlock the device 100, the system returns to step 215 looking for the unlock gesture. If the detected touch is interpreted as a unlock gesture, the system in act 225 unlocks the device 100 and animates the page turn as described above. After the unlocking of the device and the simulated page turn of the lock screen 5, the system displays the home screen of the device, or, alternatively, the last screen that was displayed on the device 100 before the lock was enabled.

In step 230, the system once again checks to see if the device 100 is PIN enabled (to be described below). If the device is not PIN enabled, the process ends in act 235.

Returning to act 205, if the device 100 is PIN enabled, the system checks to see if the dialog box for entering the user's PIN should be displayed on the lock screen 5. This choice of displaying the PIN dialog box is a decision made by the system designer, or alternatively, an option made available to the user. If the PIN dialog box is not displayed on the lock screen 5, the process proceeds through acts 210-230 as described above. In act 230, the system again tests whether the device is PIN enabled. In this route through the process the answer is YES and in step 260 it is determined if the PIN has already been processed. Again, in this route through the process, the answer is NO and the PIN dialog box is displayed on the display of the device 100 in act 265. After the user successfully enters her PIN, the security lock is removed and the process ends at step 235. Note, in the present discussion, the steps for processing the user's PIN are not described as these are well know in the art. For the purposed of this FIG. 2, it is assumed the user correctly enters her PIN for unlocking the security lock.

Returning to step 240, if the system is set to display the PIN dialog on the lock screen 5, the dialog is displayed on act 245. At some point, when the user wants to use the device 100, she inputs her PIN, which is processed in act 250 to unlock the PIN enabled security. In act 255, the system determines if a user touch gesture is required to unlock the lock screen 5. In one embodiment of the present invention, the input of the user's PIN is enough to unlock the lock screen 5 and, taking the NO path out of determination 255, the system animates the page turn in act 255 and displays the appropriate screen. In act 230, it is determined that the device 100 is PIN enabled and in act 260 it is determined that the PIN has already been processed. As the device has been completely unlocked, the process ends in act 235.

Returning to determination 255, if the user, or the system designed has chosen to require both the PIN input and the unlock gesture to completely unlock the device 100, the YES route is taken and the system displays the curl animation 15 to visually cue the user to the required gesture. The process proceeds through the acts 215-225 to unlock the screen lock 5 and display the appropriate display screen. In act 230, it is determined that the device 100 is PIN enabled and in act 260 it is determined that the PIN has already been processed. As the device has been completely unlocked, the process ends in act 235.

FIG. 2 illustrates a preferred embodiment of the process of the present invention. Other additions or modifications to the process can be made while not departing from the spirit and scope of the invention.

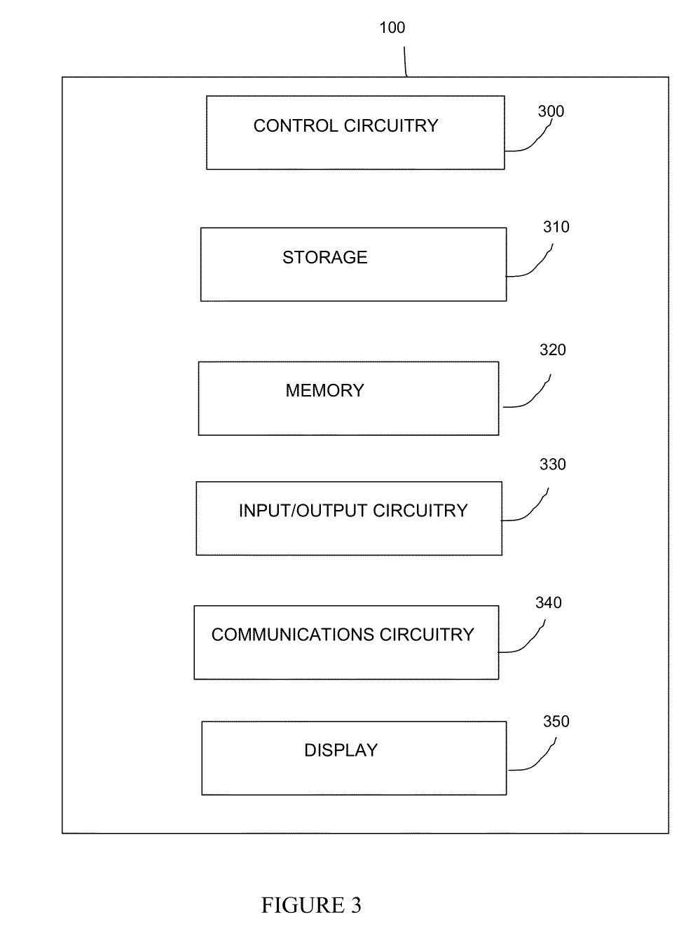

FIG. 3 illustrates an exemplary device 100 for operating the present invention. As appreciated by those skilled the art, the device 100 can take many forms capable of operating the present invention. In a preferred embodiment the device 100 is a mobile electronic device, and in an even more preferred embodiment device 100 is an electronic reader device. Electronic device 100 can include control circuitry 300, storage 310, memory 320, input/output (“I/O”) circuitry 330, communications circuitry 340, and display 350. In some embodiments, one or more of the components of electronic device 100 can be combined or omitted, e.g., storage 310 and memory 320 may be combined. As appreciated by those skilled in the art, electronic device 100 can include other components not combined or included in those shown in this Figure, e.g., a power supply such as a battery.

Electronic device 100 can include any suitable type of electronic device. For example, electronic device 100 can include a portable electronic device that the user may hold in his or her hand, such as a digital media player, a personal e-mail device, a personal data assistant (“PDA”), a cellular telephone, a handheld gaming device, a tablet device or an eBook reader. As another example, electronic device 100 can include a larger portable electronic device, such as a laptop computer. As yet another example, electronic device 100 can include a substantially fixed electronic device, such as a desktop computer.

Control circuitry 300 can include any processing circuitry or processor operative to control the operations and performance of electronic device 100. For example, control circuitry 300 can be used to run operating system applications, firmware applications, media playback applications, media editing applications, or any other application. Control circuitry 300 can drive the display 350 and process inputs received from a user interface, e.g., the touch screen portion of display 350.

Storage 310 can include, for example, one or more non-transitory computer readable storage mediums including a hard-drive, solid state drive, flash memory, permanent memory such as ROM, magnetic, optical, semiconductor, paper, or any other suitable type of storage component, or any combination thereof. Storage 310 can store, for example, media content, e.g., eBooks, music and video files, application data, e.g., software for implementing functions on electronic device 100, firmware, user preference information data, e.g., content preferences, authentication information, e.g., libraries of data associated with authorized users, transaction information data, e.g., information such as credit card information, wireless connection information data, e.g., information that can enable electronic device 100 to establish a wireless connection, subscription information data, e.g., information that keeps track of podcasts or television shows or other media a user subscribes to, contact information data, e.g., telephone numbers and email addresses, calendar information data, and any other suitable data or any combination thereof. The instructions for implementing the functions of the present invention may, as non-limiting examples, comprise software and/or scripts stored in the computer-readable media 310.

Memory 320 can include cache memory, semi-permanent memory such as RAM, and/or one or more different types of memory used for temporarily storing data. In some embodiments, memory 320 can also be used for storing data used to operate electronic device applications, or any other type of data that can be stored in storage 310. In some embodiments, memory 320 and storage 310 can be combined as a single storage medium.

I/O circuitry 330 can be operative to convert, and encode/decode, if necessary analog signals and other signals into digital data. In some embodiments, I/O circuitry 330 can also convert digital data into any other type of signal, and vice-versa. For example, I/O circuitry 330 can receive and convert physical contact inputs, e.g., from a multi-touch screen, i.e., display 350, physical movements, e.g., from a mouse or sensor, analog audio signals, e.g., from a microphone, or any other input. The digital data can be provided to and received from control circuitry 300, storage 310, and memory 320, or any other component of electronic device 100. Although I/O circuitry 330 is illustrated in this Figure as a single component of electronic device 100, several instances of I/O circuitry 330 can be included in electronic device 100.

Electronic device 100 can include any suitable interface or component for allowing a user to provide inputs to I/O circuitry 330. For example, electronic device 100 can include any suitable input mechanism, such as a button, keypad, dial, a click wheel, touchpad, or a touch screen, e.g., display 350.

In some embodiments, electronic device 100 can include specialized output circuitry associated with output devices such as, for example, one or more audio outputs. The audio output can include one or more speakers, e.g., mono or stereo speakers, built into electronic device 100, or an audio component that is remotely coupled to electronic device 100, e.g., a headset, headphones or earbuds that can be coupled to device 100 with a wire or wirelessly.

Display 350 includes the display and display circuitry for providing a display visible to the user. For example, the display circuitry can include a screen, e.g., an LCD screen, which is incorporated in electronics device 100. In some embodiments, the display circuitry can include a coder/decoder (Codec) to convert digital media data into analog signals. For example, the display circuitry or other appropriate circuitry within electronic device 100 can include video Codecs, audio Codecs, or any other suitable type of Codec.

The display circuitry also can include display driver circuitry, circuitry for driving display drivers, or both. The display circuitry can be operative to display content, e.g., media playback information, application screens for applications implemented on the electronic device 100, information regarding ongoing communications operations, information regarding incoming communications requests, or device operation screens, under the direction of control circuitry 300. Alternatively, the display circuitry can be operative to provide instructions to a remote display.

Communications circuitry 340 can include any suitable communications circuitry operative to connect to a communications network and to transmit communications, e.g., data from electronic device 100 to other devices within the communications network. Communications circuitry 340 can be operative to interface with the communications network using any suitable communications protocol such as, for example, Wi-Fi, e.g., a 802.11 protocol, Bluetooth, radio frequency systems, e.g., 900 MHz, 1.4 GHz, and 5.6 GHz communication systems, infrared, GSM, GSM plus EDGE, CDMA, quadband, and other cellular protocols, VOIP, or any other suitable protocol.

Electronic device 100 can include one more instances of communications circuitry 340 for simultaneously performing several communications operations using different communications networks, although only one is shown in this Figure to avoid overcomplicating the drawing. For example, electronic device 100 can include a first instance of communications circuitry 340 for communicating over a cellular network, and a second instance of communications circuitry 340 for communicating over Wi-Fi or using Bluetooth. In some embodiments, the same instance of communications circuitry 340 can be operative to provide for communications over several communications networks.

In some embodiments, electronic device 100 can be coupled to a host device such as remote servers for data transfers, synching the communications device, software or firmware updates, providing performance information to a remote source, e.g., providing reading characteristics to a remote server, or performing any other suitable operation that can require electronic device 100 to be coupled to a host device. Several electronic devices 100 can be coupled to a single host device using the host device as a server. Alternatively or additionally, electronic device 100 can be coupled to several host devices, e.g., for each of the plurality of the host devices to serve as a backup for data stored in electronic device 100.

Although the present invention has been described in relation to particular embodiments thereof, many other variations and other uses will be apparent to those skilled in the art. It is preferred, therefore, that the present invention be limited not by the specific disclosure herein, but only by the gist and scope of the disclosure.

What is claimed is:

1. A method for facilitating the unlocking of an electronic device comprising:
displaying a lock screen on a display of the device;
detecting a touch on a touch sensitive surface of the device;
determining if the detected touch is an unlock gesture;
if the detected touch is an unlock gesture, simulating a page turn of the lock screen and displaying a different screen.

2. The method according to claim 1, further comprising displaying a curled edge of the lock screen to provide a visual cue for the unlock gesture.

3. The method according to claim 2, further comprising animating the curling of the displayed curled edge of the lock screen.

4. The method according to claim 2, wherein the displayed curled edge of the lock screen is a static display.

5. The method according to claim 1, wherein the act of determining if the detected touch is an unlock gesture further comprises determining if the gesture was greater than a predetermined length.

6. The method according to claim 1, wherein the act of determining if the detected touch is an unlock gesture further comprises determining if the gesture substantially followed a predetermined path.

7. The method according to claim 1, further comprising:
displaying a Personal Identification Number, PIN, dialog box on the lock screen;
accepting a PIN input into the PIN dialog box; and
disabling a security lock if the input PIN matches a predetermined PIN.

8. The method according to claim 1, further comprising:
after simulating the page turn of the lock screen, displaying a Personal Identification Number, PIN, dialog box on the different screen;
accepting a PIN input into the PIN dialog box; and
disabling a security lock if the input PIN matches a predetermined PIN.

9. A method for facilitating the unlocking of an electronic device comprising:
displaying a lock screen on a display of the device;
displaying a Personal Identification Number, PIN, dialog box on the lock screen;
accepting a PIN input into the PIN dialog box;
disabling a security lock if the input PIN matches a predetermined PIN; and
simulating a page turn of the lock screen and displaying a different screen.

10. A non-transitory computer-readable media comprising a plurality of instructions that, when executed by at least one electronic device, cause the at least one electronic device to:
display a lock screen on a display of the electronic device;
detect a touch on a touch sensitive surface of the electronic device;
determine if the detected touch is an unlock gesture; and
if the detected touch is an unlock gesture, simulate a page turn of the lock screen and display a different screen.

11. The non-transitory computer-readable media according to claim 10, wherein plurality of instructions that, when executed by at least one electronic device, cause the at least one electronic device to further display a curled edge of the lock screen to provide a visual cue for the unlock gesture.

12. The non-transitory computer-readable media according to claim 11, wherein plurality of instructions that, when executed by at least one electronic device, cause the at least one electronic device to further animate the curling of the displayed curled edge of the lock screen.

13. The non-transitory computer-readable media according to claim 10, wherein plurality of instructions that, when executed by at least one electronic device, cause the at least one electronic device to further determine if the gesture was greater than a predetermined length.

14. A non-transitory computer-readable media comprising a plurality of instructions that, when executed by at least one electronic device, cause the at least one electronic device to:
display a lock screen on a display of the electronic device;
display a Personal Identification Number, PIN, dialog box on the lock screen;
accept a PIN input into the PIN dialog box;
disable a security lock if the input PIN matches a predetermined PIN; and
simulate a page turn of the lock screen and displaying a different screen.

15. An electronic device comprising:
a memory that includes instructions for operating the electronic device;
a display;
a touch sensitive input device; and
control circuitry coupled to the memory, coupled to the touch sensitive input device and coupled to the display, the control circuitry executing the instructions and is operable to:
display a lock screen on a display of the electronic device;
detect a touch on a touch sensitive surface of the electronic device;
determine if the detected touch is an unlock gesture;
if the detected touch is an unlock gesture, simulate a page turn of the lock screen and display a different screen.

16. The electronic device according to claim 15, wherein the control circuitry is further operable to display curled edge of the lock screen to provide a visual cue for the unlock gesture.

17. The electronic device according to claim 16, wherein the control circuitry is further operable to animate the curling of the displayed curled edge of the lock screen.

18. The method according to claim 15, wherein the control circuitry is further operable to determine if the gesture was greater than a predetermined length.

19. An electronic device comprising:
a memory that includes instructions for operating the electronic device;
a display;
a touch sensitive input device; and
control circuitry coupled to the memory, coupled to the touch sensitive input device and coupled to the display, the control circuitry executing the instructions and is operable to:
display a lock screen on a display of the electronic device;
display a Personal Identification Number, PIN, dialog box on the lock screen;
accept a PIN input into the PIN dialog box;
disable a security lock if the input PIN matches a predetermined PIN; and
simulate a page turn of the lock screen and displaying a different screen.
